(19) United States
(12) Patent Application Publication
(10) Pub. No.: US 2013/0330152 A1
(43) Pub. Date: Dec. 12, 2013

(54) Combination Hay Bale Accumulator, Grapple, Loader, and Offloader

(71) Applicant: Sagebrush Metal Art, Inc., Rockmart, GA (US)

(72) Inventor: Ken Sargent, Rockmart, GA (US)

(73) Assignee: Sagebrush Metal Art, Inc., Rockmart, GA (US)

(21) Appl. No.: 13/859,281

(22) Filed: Apr. 9, 2013

Related U.S. Application Data
(60) Provisional application No. 61/621,730, filed on Apr. 9, 2012.

(51) Int. Cl. A01D 90/08

(52) U.S. Cl. CPC A01D 90/08
USPC 414/111; 414/812

(57) ABSTRACT

An apparatus for use in farming and ranching for handling square hay bales. The farming apparatus is generally attached to a lift vehicle, and includes divider plates and divider walls removably attached underneath a frame body to define accumulation bays. The farming apparatus is moved around a field where square hay bales lie to scoop the hay bales into the accumulation bays in a predetermined arrangement. When the bays are full, a plurality of grapple hooks are rotated into the hay bales to hold them in place within the farming apparatus. The hay bales are then carried and placed atop a trailer or truck, and released from the farming apparatus by disengaging the grapple hooks. For offloading, the divider plates and divider walls are removed from the frame body and the process is generally reversed to remove bales from the trailer and move them to storage or another location.

### RELATED APPLICATION

This application claims the benefit of U.S. Provisional Patent Application No. 61/621,730, filed Apr. 9, 2012, which is hereby incorporated by reference in its entirety herein, and for all purposes.

### TECHNICAL FIELD

This patent disclosure relates generally to hay farming and more particularly to farming apparatus and methods for gathering, loading, and offloading square hay bales in the field.

### BACKGROUND

Handling baled hay can be a backbreaking and time consuming job. Gathering the bales, lifting them onto a truck, and then offloading them is hard work. A need exists for an apparatus and method of gathering, loading, and offloading hay bales, particularly square hay bales, that greatly reduces the manual labor, time, and dangers attendant manual hay handling techniques. It is to the provision of such an apparatus and method that the present invention is primarily directed.

### SUMMARY

Briefly described, in one example embodiment an apparatus is disclosed for use in farming and ranching to handle square hay bales quickly and easily. The apparatus combines the functions of a hay bale accumulator, grapple, loader, and offloader into a single farming apparatus that attaches to a lift vehicle, such as a skid steer or a farm tractor. The farming apparatus has a front end defining the inlets of accumulation bays that are sized to receive hay bales when the farming apparatus is moved across a field containing square hay bales that have been previously baled by a hay baling machine. When the accumulation bays are full of hay bales, the operator can activate a multi-hook grapple assembly to pierce the bales with the hooks of the assembly and thereby secure them in the bays. With the bales secured, the farming apparatus can be lifted using the lift system of the lift vehicle and placed on a truck or trailer for transportation to a storage facility. The grapple assembly is then released and the bales are loaded as a group without having been touched by a human. Certain components that define the bays can be easily removed so that the farming apparatus can be used to offload the hay bales from the truck or trailer and move them into a storage facility, such as a barn.

In another representative embodiment of the present disclosure, a farming apparatus for accumulating, grappling and lifting hay bales that includes a frame body comprising a top frame having a front end, a back end, and side edges forming a substantially horizontal plane, a back rail assembly extending downward from the back end, and at least one attachment portion on the back rail assembly for coupling the frame body to a lift vehicle. In a first or accumulating/loading configuration, the farming apparatus generally includes a pair of packing arms removably attached between the back rail assembly and the front corners of the top frame and extending downward below the side edges of the top frame, one or more center dividers removably attached between the back rail assembly and the front end of the top frame and extending downward below a center portion of the top frame, and a plurality of divider plates removably attached between the back rail assembly and the top frame between the center dividers and the packing arms to form at least four bays that open toward the front end and that are sized and shaped to receive a hay bale. The farming apparatus further includes a grapple assembly mounted to the frame body above the bays, and that is configured to rotate a plurality of grapple hooks into any hay bales accumulated within the bays, and to removably secure the hay bales to the frame body when frame body is lifted by the lifting vehicle.

In a second or offloading configuration, the farming apparatus generally includes a single packing arm that is removably attached to either side of the frame body between the back rail assembly and a front corner of the top frame, and extending downward below the side edge of the top frame. During storage of the farming apparatus in the offloading configuration, a corner support leg can be removably attached to the front corner of the top frame opposite the packing arm to maintain the top support in a horizontal orientation and prevent the support frame from twisting or warping under its own weight. In a third or alternative offloading configuration, there are no dividers or packing arms attached to the frame body.

These and other aspects, features, and advantages of the apparatus and method disclosed herein will become more apparent upon review of the detailed description set forth below taken in conjunction with the accompanying drawing figures, which are briefly described as follows.

### BRIEF DESCRIPTION OF THE DRAWINGS

FIG. 1 is a forward, side perspective view of a farming apparatus, in accordance with a representative embodiment.

FIG. 2 is a rearward, side perspective view of the farming apparatus of FIG. 1.

FIG. 3 is a rear perspective view of the farming apparatus of FIG. 1 illustrating the multi-hook grapple assembly of the farming apparatus.

FIG. 4 is a forward, side perspective view of the farming apparatus of FIG. 1 in a first alternative configuration.

FIG. 5 is a forward, side perspective view of the farming apparatus of FIG. 1 in a second alternative configuration.

FIG. 6 is a side perspective view of the farming apparatus coupled to a lift vehicle, in accordance with another representative embodiment.

FIG. 7 shows the farming apparatus of FIG. 6 coupled to a lift vehicle and with its bays partially filled and approaching a hay bale in the field.

FIG. 8 shows the farming apparatus of FIG. 6 coupled to a lift vehicle and with its bays filled with hay bales accumulated from the hay field and secured to the farming apparatus with the grapple assembly.

FIG. 9 shows the farming apparatus of FIG. 6 coupled to a lift vehicle and with hay bales secured therein and being lifted atop a trailer to place the accumulated bales on top of previously gathered and loaded bales.

FIG. 10 shows the farming apparatus coupled to a lift vehicle and having certain divider components being removed to convert the farming apparatus to an offloading configuration, in accordance with another representative embodiment.

FIG. 11 shows the farming apparatus of FIG. 10 in an offloading configuration and coupled to a lift vehicle, and with the multiple hooks of the grapple system being rotated to secure a plurality of hay bales to the frame of the farming apparatus.

FIG. 12 is a forward, side perspective view of a farming apparatus, in accordance with another representative embodiment.

FIG. 13 is a rearward, side perspective view of the farming apparatus of FIG. 12.

### DETAILED DESCRIPTION

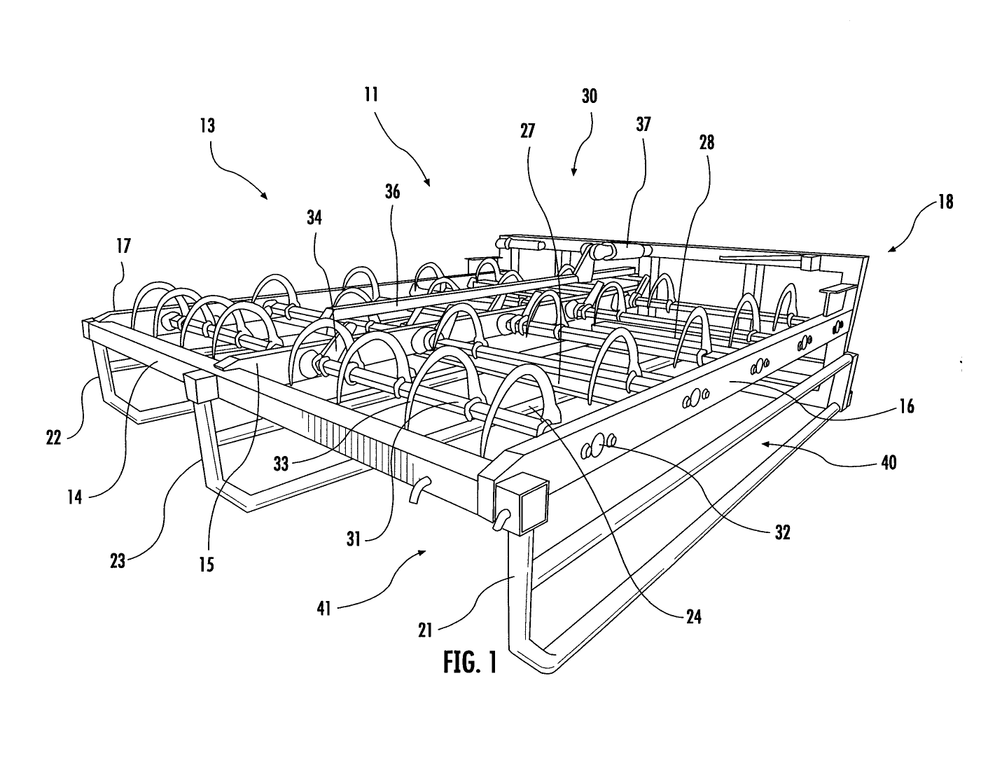

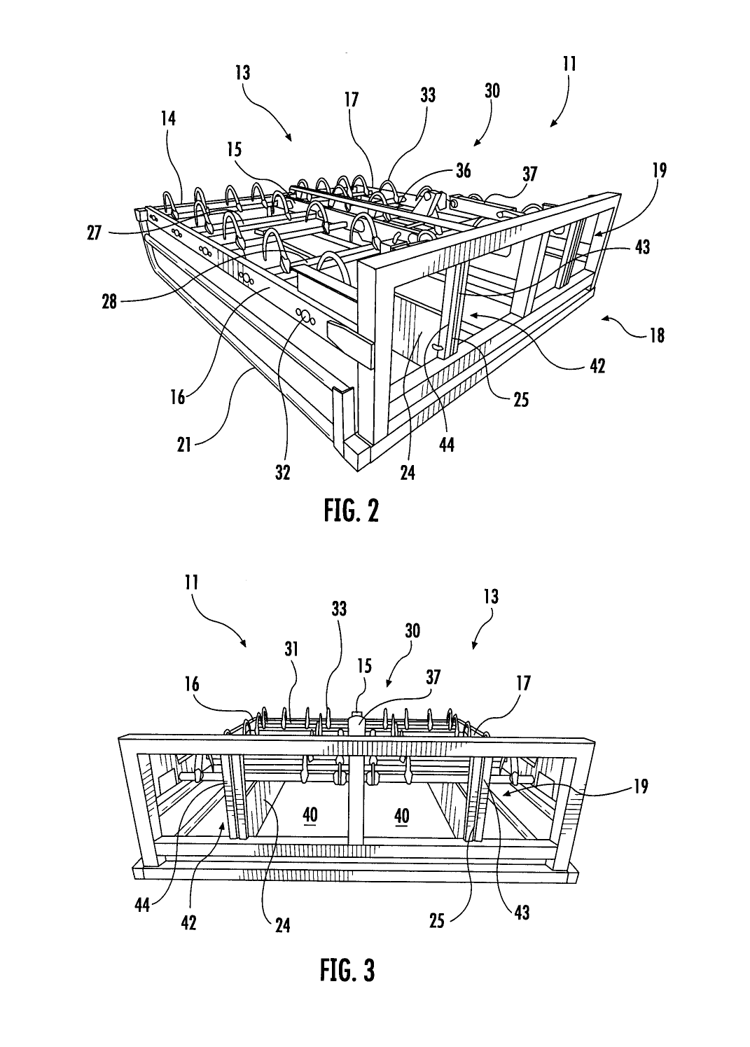

Referring now in more detail to the drawing figures, wherein like reference numerals indicate like parts throughout the several views, FIGS. 1 and 2 are a side perspective views of a farming apparatus 11 that embodies principles of the invention disclosed herein in one preferred form, and FIG. 3 is a rear perspective view. The farming apparatus 11 comprises a frame body 13 made up of a front rail 14, a center rail 15, and side rails 16 and 17 forming a substantially horizontal plane, and a back rail or rear support assembly 18 that extends downward from the horizontal plane. The back rail assembly 18 can include an attachment portion 19 for coupling the frame body 13 to a lift vehicle. The center rail 15 extends through the center portion of the frame body 13 between the front rail 14 and the back rail assembly 18. Hay plates or cross plates 27 and 28 extend between the side rails 16 and 17 and the center rail 15 to complete the frame body 13.

The farming apparatus 11 of the present disclosure is generally configured to perform all the functions of handling square hay bales, including accumulating, grappling, loading and unloading square hay bales. It will be appreciated by one of skill in the art, however, that “square hay bale” is a term of art, and generally refers to rectangular-shaped bales of hay having a long axis through a length thereof, and that may be square in cross-section when viewed along a plane oriented perpendicular to the long axis (i.e. the height and width of the hay bale). However, significant variability can exist with the height of the hay bales, even as the length and the width of the bales are maintained at more or less constant values, so that the end faces of the bale are often rectangular in shape, rather than square.

A grapple assembly 30 is supported by the frame body 13 and comprises a plurality of grapple shafts 31 that extend between the side rails 16 and 17 and through the center rail 15. The grapple shafts 31 are rotatably journaled within bearings 32 in the side rails 16 and 17 and in the center rail 15 so that they are rotatable about their respective axes. A plurality of arcuate sharpened grapple hooks 33 are mounted to each grapple shaft with brackets and bolts. In the illustrated embodiments, each grapple shaft 31 has four grapple hooks 33 except for the forward most grapple shaft, which can be provided with eight grapple hooks 33.

As best illustrated in FIG. 1, packing arms 21 and 22 can be removably attached between the front corners of the frame body 13 and the back rail assembly 18, and extend downward below the side rails 16 and 17 to form the side boundaries of the farming apparatus 11 in a first or accumulating/loading configuration. In addition, a center divider wall 23 is removably attached between the front rail 14 and the back rail assembly 18 and extends downward below the center rail 15 of the frame body 13. A pair of divider plates 24 are also removably attached to the frame body 13 of the farming apparatus 11 with locking tongues along an upper edge that can be slide locked within slots in the cross plates 27 and 28, and with rear edges 25 that couple with the back rail assembly 18 or rear support assembly.

Each divider plate 24 divides the space between a packing arm 21 or 22 and the center divider wall 23 into two accumulation bays 40 for receiving two or more square bales lengthwise within the bays as the farming apparatus 11 is moved around a field to capture and accumulate the bales. Thus, with both divider plates 24 mounted to the frame body 13, the area under the frame body is divided into four bays that open toward the front end of the frame body 13. In one aspect of the disclosure, moreover, the divider plates 24 may not extend all the way to the front end of the frame body 13, but instead can stop short by about the width of a square bale to form a forward, crossways space 41 in front of the bays 40 and under the frame body 13. In this way, each of the last two bales to enter the farming apparatus 11 can be oriented crossways within the crossways space 41, or in a direction perpendicular to the orientation of the bales that have already been captured within the accumulation bays 40.

In the embodiment of the farming apparatus 11 shown in FIGS. 1-3, having a single center divider wall 23, the two divider plates 22 and the two packing arms 21 and 22, each of the four accumulation bays 40 found on either side of the center divider wall 23 can hold two hay bales in a lengthwise orientation (i.e. having their long axis oriented parallel to the center divider), as well as additional bales in a crossways orientation (i.e. having its long axis oriented perpendicular to the center divider) in the crossways spaces 41 in front of the divider plates 24. Thus, the farming apparatus 11 can accumulate and secure up to ten bales of hay in a group below the frame body 13, with the two forward-most bales being oriented crossways to the remaining eight bales that are oriented lengthwise.

In one aspect, the group of ten hay bales having the mixed or alternating alignment between the individual hay bales can then be loaded onto a truck or trailer. When the overall alignment of adjacent groups of hay bales are alternated, such as when adjacent groups or alternating rows of hay bales groups are loaded onto the trailer from opposite sides, the individual hay bales and groups of hay bales can become “interlocked” together in a preferred loading configuration that better holds the groups of hay bales together, resists tipping, and minimizes the strapping that is needed to secure the load of hay for transport.

It can also be seen in FIGS. 1-3 that the grapple hooks 33 on all but the forward most grapple shaft 31 align with the bays formed below by the divider plates 24, the center divider wall 23, and the packing arms 21 and 22 defining the side boundaries of the farming apparatus 11. Thus, the grapple hooks will also align with hay bales accumulated within the bays when the accumulator function of the farming apparatus 11 is completed. Each of the grapple shafts 31 has an arm 34 that projects from its central portion and the arms of the shafts are interconnected to an actuator bar 36 extending along the top of the farming apparatus 11. It will thus be seen that forward and rearward movement of the actuator bar 36 results in simultaneous rotation of all of the grapple shafts 31.

A hydraulic cylinder 37 is secured at its back end to the back rail assembly 18 of the farming apparatus 11, and its extendable and retractable shaft is connected at its end to the actuator bar 36. Accordingly, when the shaft of the hydraulic cylinder is extended, the grapple shafts 31 are caused to rotate forwardly, which in turn rotates the grapple hooks 33 around and down into the bays and space below the frame 13. Of course, if hay bales have been accumulated in these regions, the grapple hooks pierce the hay bales and hold them in place, so that the farming apparatus 11 with hay bales grappled thereto can be lifted by the lift vehicle, such as a skid steer or tractor, to which the farming apparatus 11 is mounted. When the hydraulic cylinder 37 is retracted, the grapple hooks 33 are rotated upwardly and rearwardly to release the hay bales below.

With reference to FIGS. 2 and 3, the back rail assembly 18 can include two vertically-extending tubing pairs 42, with each tubing pair having a vertical gap 43 between two tubing elements 44. In one aspect, the rear edges 25 of the divider plates 24 can slide into the vertical gaps 43 to align and secure the divider plates 24 into position underneath the frame body 13. In another aspect, each of the tubing pairs 42 can also be sized and shaped to provide the attachment portion 19 for back rail assembly 18 that can be clamped with any one of a variety of attachment devices to secure the farming apparatus 11 to the lift vehicle. Alternatively, specialized mounting brackets (not shown) as commonly known in the art can be mounted to the attachment portion 19 or tubing pairs 42 of the back rail assembly 18 for securing the farming apparatus 11 to the lift vehicle.

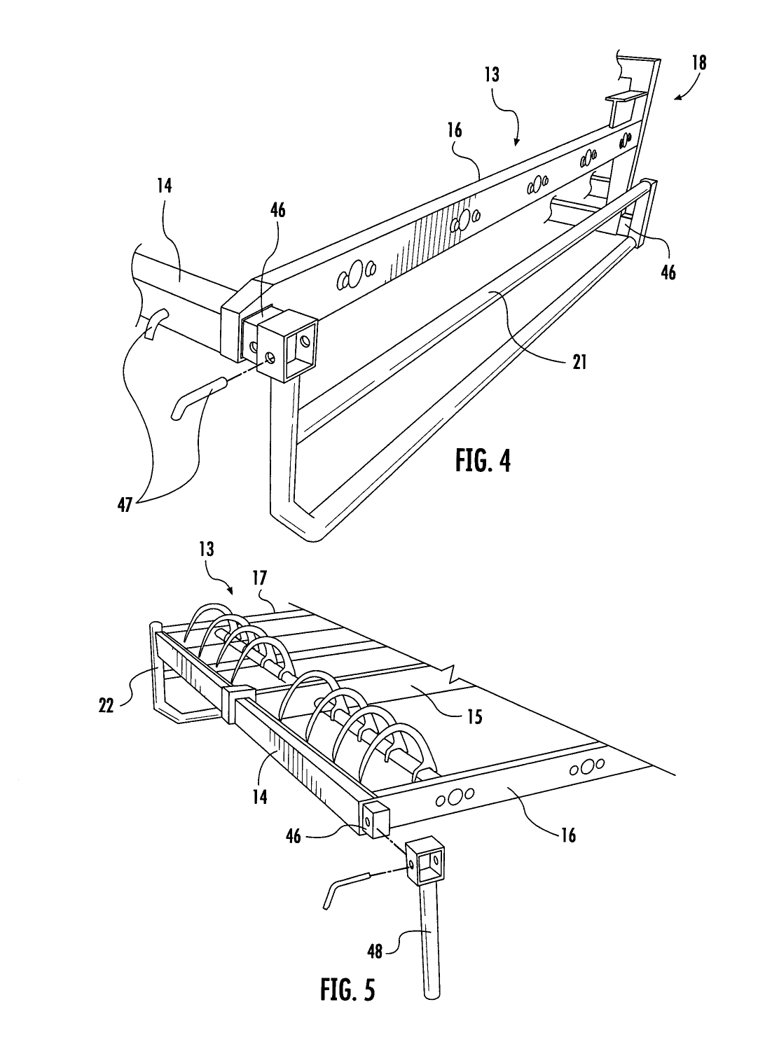

Illustrated in FIG. 4 is another aspect of the present disclosure, in which the packing arms 21 and 22 are laterally adjustably coupled to the frame body 13 for expanding the spacing between the pair of packing arms and underneath the frame body 13. As shown, the packing arm 21 can be coupled to the front corner of the frame body 13 and to the lower back corner of the back rail assembly 18 through the use of adjustable mounted bars 46. The mounting bars 46 can slide laterally within the hollow front rail 14 and the hollow lowest rail of the back rail assembly 18, with the packing arm 21 being attached with a pin 47 to the mounting bars 46 and the mounting bars being attached with a pin 47, in turn, to the front rail 14 and the back rail assembly 18. In one aspect, the packing arm 21 is laterally adjustable outward by about three inches or more.

As will be discussed in more detail below, the packing arms, the center divider wall, and the divider plates are removably attached to the frame body 13, and all but one of the packing arms 22 is typically removed when converting the farming apparatus 11 to a second or offloading configuration, as shown in FIG. 5. In one aspect, an extra corner support leg 48 can be coupled to the opposite side of the frame body when the farming apparatus is in the offloading configuration but not in actual use, so that the frame body does not become twisted or warped under its own weight. In addition, the remaining packing arm can be attached to either side of the frame body 13, depending from which side of the trailer the operator intends to offload the stacked hay bales.

FIGS. 6-11 illustrate various aspects of the method carried out by the apparatus described above to accumulate, transport, load, and offload square hay bales. As shown in FIG. 6, the farming apparatus 11 in the first or accumulator/loader configuration is coupled to a lift vehicle 50, such as a skid steer. To accumulate and arrange the hay bales, the farming apparatus 11 is pushed around a hay field to “scoop up” the individual bales into the accumulation bays 40. The farming apparatus 11 may also be carried a slight distance above the ground by the lift vehicle 50 so that the bottom surfaces of the packing arms 21 and 22 and the center dividing wall 23 do not drag along the ground surface. As the bales of hay are encountered, they tend to automatically rotate and align with the accumulation bays 40, and eventually slide into the accumulation bays 40 as they are pushed across the ground. The hay bales are thus automatically arranged into the desired configuration as they are captured within the accumulation bays 40.

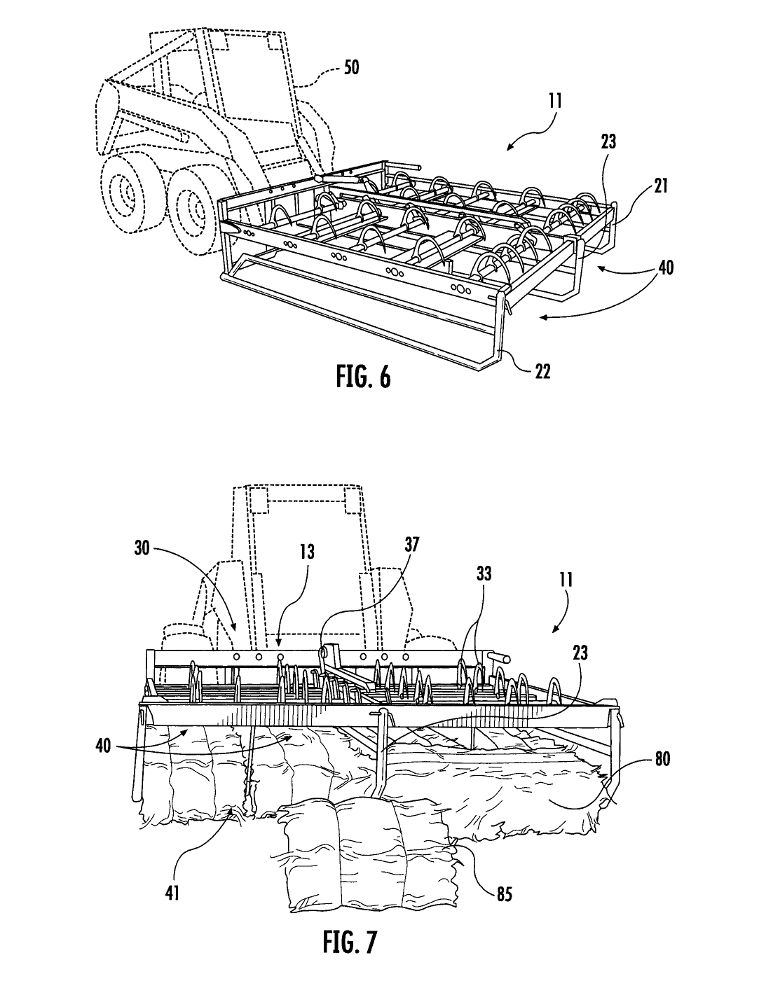

As shown in FIG. 7, it can be seen that the bays 40 of the farming apparatus 11 are almost full of hay bales 80, with only the left front bay location still empty. The farming apparatus 11 is being pushed toward the last hay bale 85 to be loaded to fill the farming apparatus 11. Contact between the center divider wall 23 of the farming apparatus 11 and the rear face of the hay bale 85 causes the hay bale 85 to rotate clockwise into alignment with the last remaining crossways slot, while the continued forward movement of the farming apparatus 11 causes the hay bale 85 to move completely into and become packed within the crossways slot, at which point the accumulation function of the apparatus is completed.

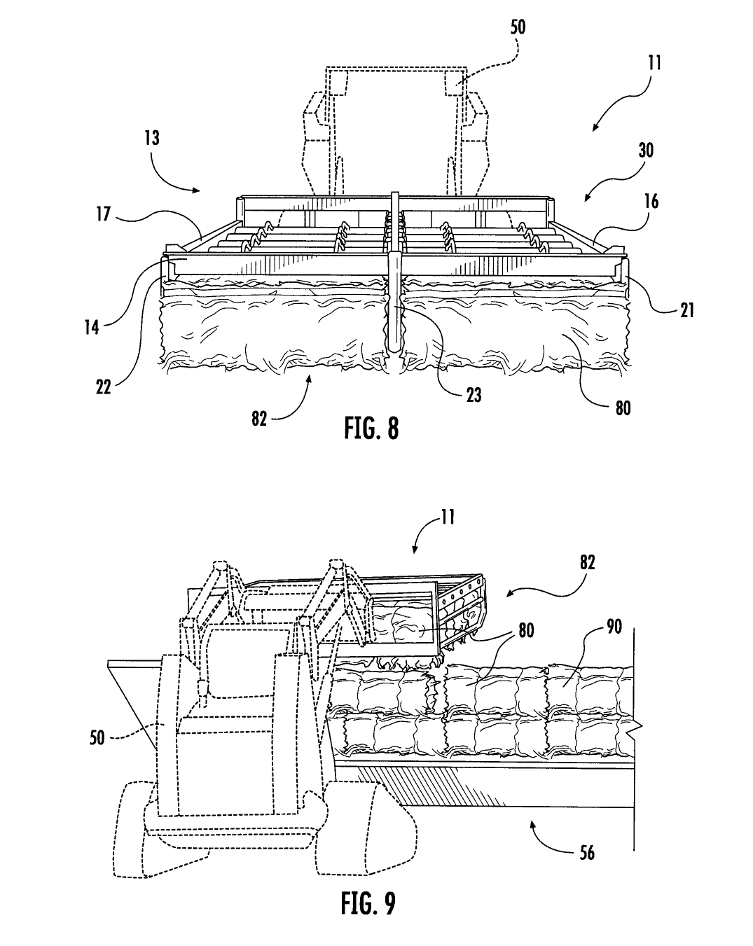

Once the accumulation bays 40 of the farming apparatus 11 are filled with hay bales 40, the frame body 13 of the farming apparatus 11 is lowered atop the accumulated hay bales 80. The operator then engages the hydraulic system of the skid steer or tractor to extend the hydraulic cylinder 37 of the grapple assembly 30. This causes the grapple hooks 33 to be rotated forward and downwardly so that they pierce and hook into the bales 80 below. This secures the bales 80 firmly in place within the bays 40 of the farming apparatus 11. With the hay bales thus secured, the operator lifts the farming apparatus 11 with the group 82 of hay bales 80 secured therein, as shown in FIG. 8.

In one alternative method, the operator can sequentially drive the farming apparatus 11 over each individual hay bale 80 to position or align the hay bale with one of the bay 40, lower the frame body 13 and engage hay bale 80 with the grappling system 30 to secure the hay bale to the farming apparatus 11, and then lift the frame body 13 to carry the secured hay bales 80 to the location of the next hay bale on the field. The steps of aligning, lowering, securing and lifting can be performed for one or more hay bales, so that the hay bales are not continuously pushed over the ground surface in a manner that can cause them to loose material or break apart.

When the farming apparatus 11 has collected the desired number of hay bales 80, the operator can then drive the skid steer 50 to the location of a truck or trailer 56 on which the bales are to be loaded. As illustrated in FIG. 9, when the operator reaches the trailer 56, the farming apparatus 11 is lifted up by the skid steer 50 so that it may be placed on the trailer atop any previously loaded layers 90 of hay bales 80. Once the new bales are positioned and lowered, the operator activates the hydraulic system in the opposite direction to retract the hydraulic cylinder. This rotates the grapple hooks rearwardly and upwardly so that they disengage with and release the group 82 of hay bales 80 below. The operator can then lift the farming apparatus leaving the bales behind on the trailer and return to the field to gather more bales for loading.

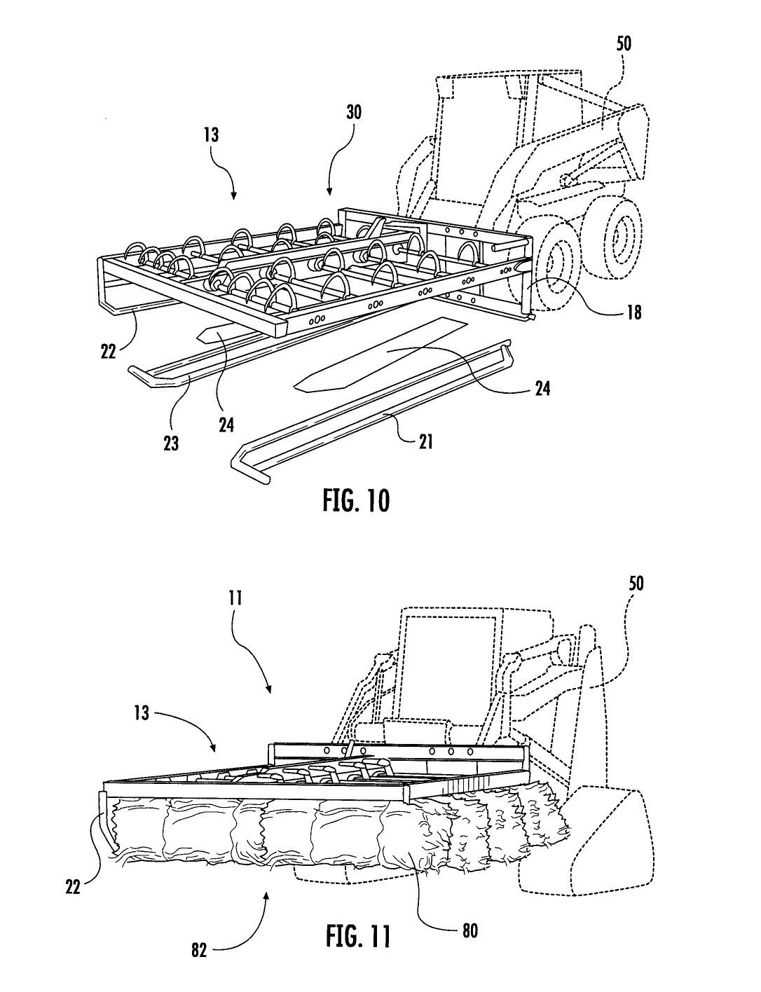

There also is a need to be able to offload hay bales from the trailer for storage in a hay loft or hay barn awaiting use as feed. To facilitates such offloading, the farming apparatus 11 of the present invention can be converted to a second or offloading configuration with only a few easy changes, which are illustrated in FIGS. 10 and 11. First, the operator removes the divider plates 24 and the center divider wall 23. In one aspect, the divider plates 24 can be removed by sliding them forward until their locking tabs disengage from the slots of the cross plates, whereupon they drop away. The center divider wall 23 may also be disengaged from the farm apparatus 11 by removing pins that secure it to the frame body 13, and then pulling the center divider wall 23 forward until it slides off its mounting fixtures and drops away. As illustrated in FIG. 10, the operator can also remove at least one of the packing arms 21 that is removably coupled to one or the other side of the farming apparatus 11, depending upon which side of the trailer will be approached when offloading hay bales.

Now in its offloading configuration, the farming apparatus 11 can be lifted atop hay bales on a trailer, lowered over a group 82 of hay bales 80, and the grapple hooks 33 extended to hook into and secure the hay bales to the farming apparatus 11. The packing arm 22 extending below one side of the frame body 23 can be used to push the group of hay bales closer together prior to extending the grapple hooks 33. As shown in FIG. 11, the farming apparatus 11 with secured hay bales 80 can then be lifted and transported to a storage location in a barn or the like, placed in a desired location, and released by retracting the grapple hooks.

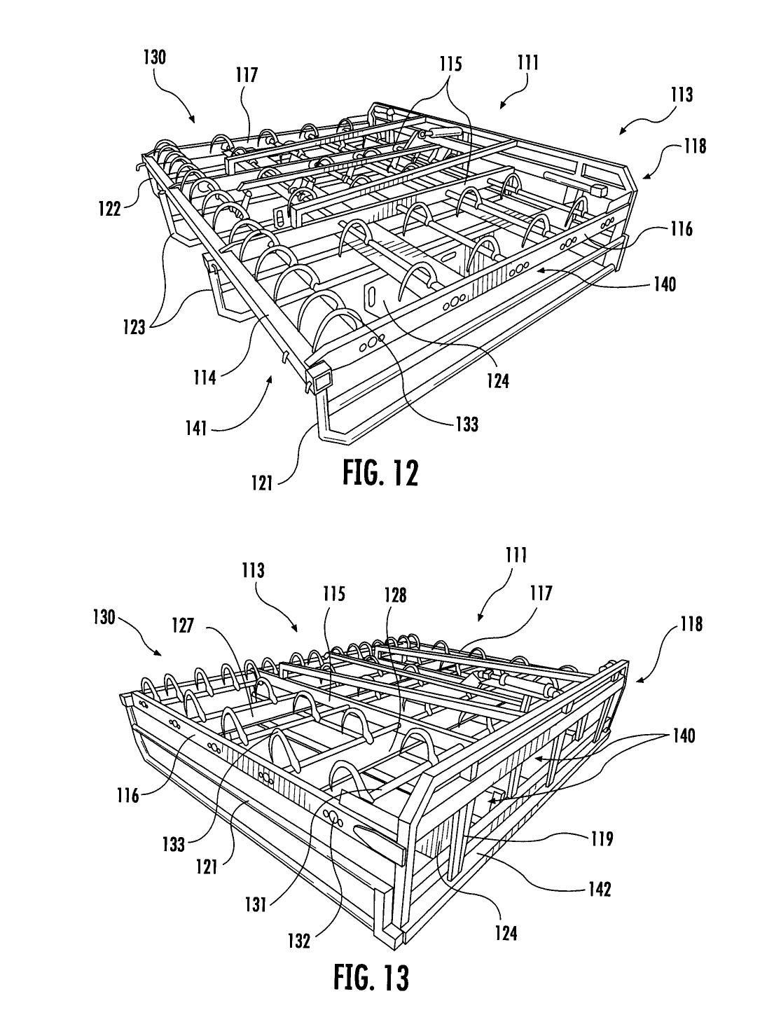

Another representative embodiment of the farming apparatus 111 that has been expanded to include two center divider walls 123 and three divider plates 124 between the packing arms 121 and 122 is shown in FIGS. 12 and 13. The additional center divider wall 123 and divider plate 124 provide for the creation of two additional accumulator bays 140 for holding hay bales in a lengthwise orientation (i.e. having their long axis oriented parallel to the center divider) and for an additional crossways space 141 for holding a hay bale in a crossway orientation (i.e. having its long axis oriented perpendicular to the center divider). Thus, the farming apparatus 111 can accumulate and secure up to fifteen bales of hay in a group below the frame body 113, with the three forward-most bales being oriented crossways to the remaining twelve bales that are oriented lengthwise.

Similar to the smaller embodiment of the farming apparatus described above, the expanded farming apparatus 111 includes the frame body 113 made up of a front rail 114, two center rails 115, and side rails 116 and 117 forming a substantially horizontal plane, and a back rail or rear support assembly 118 that extends downward from the horizontal plane. The back rail assembly 118 can also include an attachment portion 119 for coupling the frame body 113 to a lift vehicle. The center rails 115 extend through the center portion of the frame body 113 between the front rail 114 and the back rail assembly 118. Cross plates 127 and 128 extend between the side rails 116 and 117 and the center rails 115 to complete the frame body 113.

A grapple assembly 130 is also supported by the frame body 113 of the farming apparatus 111, and comprises a plurality of grapple shafts 31 that extend between the side rails 116 and 117 and through the center rails 115. The grapple shafts 131 are rotatably journaled within bearings 132 in the side rails 116 and 117 and in the center rails 115 so that they are rotatable about their respective axes. A plurality of arcuate sharpened grapple hooks 133 are mounted to each grapple shaft 131 with brackets and bolts. In the illustrated embodiments, each grapple shaft 131 has six grapple hooks 133 except for the forward most grapple shaft, which can be provided with twelve grapple hooks 133.

As can be seen in FIG. 13, the back rail assembly 118 can include three vertically-extending tubing pairs 142, with each tubing pair having a vertical gap between two tubing elements. In one aspect, the rear edges of the divider plates 124 can slide into the vertical gaps to align and secure the divider plates 124 into position underneath the frame body 113. In another aspect, each of the tubing pairs 142 can also be sized and shaped to provide the attachment portion 119 for back rail assembly 118 that can be clamped with any one of a variety of attachment devices to secure the farming apparatus 111 to the lift vehicle. Alternatively, specialized mounting brackets (not shown) as commonly known in the art can be mounted to the attachment portion 119 or tubing pairs 142 of the back rail assembly 118 for securing the farming apparatus 111 to the lift vehicle.

It may be appreciated by one of skill in the art that smaller embodiment 11 of the farming apparatus shown in FIGS. 1-3 may be used with the larger embodiment 111 shown in FIGS. 12-13. For instance, the larger farming apparatus 111 may be used to accumulate and load the hay bales onto a trailer, while a smaller farming apparatus 11 may be configured and used to offload the hay bales from the trailer and move them into a storage facility. In one aspect of the present disclosure, moreover, the larger farming apparatus 111 may be a scaled-up version of the smaller farming apparatus 11, so that the removably attachable components of the both the larger and smaller version of the farming apparatus, such as the packing arms, the center divider walls and the divider plates, may be interchangeable between embodiments.

It will thus be seen that the single hay handling apparatus of the present disclosure performs all of the required functions of hay gathering, including accumulating and arranging the bales, transporting the bales, loading the bales on a trailer, and offloading the bales from the trailer. This is all done without the operator having to wrangle with or lift the individual bales himself, and can be done for extended periods of time by a single operator.

The invention has been described herein within the context of a preferred and exemplary embodiment considered by the examiner to represent the best mode of carrying out the invention. However, a wide variety of additions, deletions, and modifications, both subtle and gross, might well be made to the illustrated embodiment without departing from the spirit and scope of the invention embodied therein.

What is claimed is:

1. A farming apparatus for accumulating, grappling and lifting hay bales, the farming apparatus comprising:
a frame body comprising a top frame having a front end, a back end, and side edges forming a substantially horizontal plane, a back rail assembly extending downward from the back end, and at least one attachment portion on the back rail assembly for coupling the frame body to a lift vehicle;
a pair of packing arms removably attached between the back rail assembly and the front corners of the top frame and extending downward below the side edges of the top frame;
at least one center divider removably attached between the back rail assembly and the front end of the top frame and extending downward below a center portion of the top frame;
a plurality of divider plates removably attached between the back rail assembly and the top frame between the packing arms and the at least one center divider to form at least four bays opening toward the front end and sized and shaped to receive a hay bale; and
a grapple assembly mounted to the frame body above the bays and configured to rotate a plurality of grapple hooks into hay bales accumulated within the bays, and to removably secure the hay bales to the frame body when frame body is lifted by the lifting vehicle.

2. The farming apparatus of claim 1, wherein the top frame further comprises a front rail, a center rail, side rails, and at least two cross plates extending between the side rails.

3. The farming apparatus of claim 2, wherein the grapple assembly pulls the hay bales upward against the at least two cross plates to removably secure the hay bales to the frame body.

4. The farming apparatus of claim 1, wherein the lift vehicle is a tractor or a skid steer.

5. The farming apparatus of claim 1, wherein a length of the hay bale ranges from about 36 inches to about 42 inches.

6. The farming apparatus of claim 1, wherein the bays are configured to receive a hay bale having a long axis oriented parallel with the center divider.

7. The farming apparatus of claim 6, wherein the divider plates are shorter than the packing arms to form a space proximate the front end of the frame body sized to receive a hay bale having a long axis oriented perpendicular to the center divider.

8. The farming apparatus of claim 1, wherein the grapple assembly rotates at least two grapple hooks into each hay bale received within the bays.

9. The farming apparatus of claim 1, wherein the grapple assembly further comprises:
a hydraulic actuator;
an actuator bar coupled to the hydraulic actuator; and
a plurality of cross tubes rotatably coupled to the top frame and pivotably coupled to the actuator bar, with the grapple hooks extending outward from the cross tubes,
wherein the hydraulic actuator is operable to move the actuator bar to rotate the cross tubes and actuator hooks.

10. The farming apparatus of claim 1, wherein the back rail assembly includes a plurality of vertically-extending tubing pairs, each tubing pair including a vertical gap between two tubing elements.

11. The farming apparatus of claim 10, wherein back ends of the divider plates are removably installed within the vertical gaps between tubing elements in the tubing pairs.

12. The farming apparatus of claim 10, wherein the tubing pairs further comprise the at least one attachment portion for coupling the frame body to a lifting arm of a lift vehicle.

13. The farming apparatus of claim 10, wherein the tubing elements are rectangular in cross-section.

14. The farming apparatus of claim 1, wherein the packing arms are laterally adjustably coupled to the frame body for expanding a spacing between the pair of packing arms.

15. A method for accumulating, loading and unloading hay bales, the method comprising:
obtaining a farming apparatus comprising:
a top frame forming a substantially horizontal plane and a back rail assembly extending downward from a back end of the top frame;
a pair of packing arms removably attached between the back rail assembly and the front corners of the top frame and extending downward below side edges of the top frame;
a plurality of divider plates removably attached between the back rail assembly and the top frame between the packing arms to form a least four bays that open toward a front end of the top frame and that are sized and shaped to receive a hay bale; and
at least one attachment portion on the back rail assembly for coupling the frame body to a lift vehicle;
accumulating a first plurality of hay bales within the bays by moving the farming apparatus sequentially over the hay bales distributed across a field;
securing the first plurality of hay bales with the bays;
lifting the farming apparatus with the secured first plurality of hay bales;
depositing the first plurality of hay bales onto a first support surface;
removing the farming apparatus;
disconnecting the dividers and at least one packing arm from the frame body;
placing the farming apparatus onto at least one second plurality of hay bales;
securing the second plurality of hay bales of the farming apparatus;
lifting the farming apparatus with the secured second plurality of hay bales; and
depositing the second plurality of hay bales onto a second support surface.

16. The method of claim 15, wherein the at least one packing arm is removable from either side of the frame body.

17. The method of claim 15, wherein securing a plurality of hay bales further comprises activating a grapple assembly mounted to the frame body above the bays to rotate a plurality of grapple hooks into the plurality of hay bales accumulated within the bays.

18. The method of claim 15, further comprising accumulating and securing one of the first plurality of hay bales within the farming apparatus and lifting the farming apparatus before sequentially moving to another of the first plurality of hay bales.

19. The method of claim 15, wherein accumulating the first plurality of hay bales within the bays further comprises aligning at least one first hay bale with a long axis oriented parallel with the divider plates and packing arms and at least one second hay bale with a long axis oriented perpendicular with the divider plates and packing arms.

20. The method of claim 15, further comprising moving at least one of the packing arms laterally outward from the frame body for expanding a spacing under the top frame and between the pair of packing arms.
